(19) United States
(12) Patent Application Publication
(10) Pub. No.: US 2026/0247314 A1
(43) Pub. Date: Aug. 20, 2026

(54) METHOD AND DEVICE FOR DETERMINING UPLINK TRANSMIT TIMING ADVANCE OF SATELLITE COMMUNICATION

(71) Applicant: Samsung Electronics Co., Ltd., Suwon-si, Gyeonggi-do (KR)

(72) Inventors: Yanze FU, Beijing (CN); Haijie QIU, Beijing (CN); Min WU, Beijing (CN)

(21) Appl. No.: 19/156,208

(22) PCT Filed: Feb. 15, 2024
(86) PCT No.: PCT/KR2024/095158

§ 371 Date: Aug. 13, 2025

(30) Foreign Application Priority Data
Feb. 15, 2023 (CN) 202310148314.5

(51) Int. Cl. H04W 56/00; H04W 8/24; H04W 84/06

(52) U.S. Cl. CPC H04W 56/0045; H04W 8/24; H04W 84/06

(57) ABSTRACT

The disclosure relates to a 5G or 6G communication system for supporting a higher data transmission rate. One aspect of the present disclosure relates to a method performed by user equipment (UE) in a communication system, which includes: transmitting first information related to satellite positioning of the UE to abase station; receiving assistance information related to satellite positioning transmitted in response to the first information related to satellite positioning from a base station, wherein the assistance information includes information related to at least one satellite other than a serving satellite of the UE for satellite positioning of the UE; and adjusting uplink transmit timing based on the assistance information.

### TECHNICAL FIELD

The present disclosure relates to wireless communication, and more specifically, to a method and device for determining uplink transmit timing in satellite communication.

### BACKGROUND ART

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The present disclosure may provide a method and device for determining uplink transmit timing in satellite communication.

The technical objects to be achieved by various embodiments of the disclosure are not limited to the technical objects mentioned above, and other technical objects not mentioned may be considered by those skilled in the art from various embodiments of the disclosure to be described below.

### Solution to Problem

According to an embodiment of the present disclosure, there is provided a method performed by user equipment (UE) in a communication system, comprising: transmitting first information related to satellite positioning of the UE to a base station; receiving assistance information related to the satellite positioning transmitted in response to the first information related to the satellite positioning from the base station, wherein the assistance information includes information for the satellite positioning of the UE related to at least one satellite other than a serving satellite of the UE; and adjusting uplink transmit timing based on the assistance information.

In an implementation, wherein the assistance information includes at least one of information on an additional positioning reference signal related to the at least one satellite, system information of the at least one satellite, and ephemeris information of the at least one satellite.

In an implementation, wherein the first information related to the satellite positioning includes at least one of information on a satellite positioning capability, information on a satellite positioning error, and information on a satellite positioning request (or requirement).

In an implementation, wherein the information on the satellite positioning capability is included in UE capability information, and the information on the satellite positioning error and/or the information on the satellite positioning request is included in a radio resource control (RRC) establishment request.

In an implementation, wherein an initial transmission timing error requirement that the uplink transmit timing needs to meet corresponds to a satellite positioning accuracy related information of the UE.

According to an embodiment of the present disclosure, there is provided a performed by a base station in a communication system, comprising: receiving first information related to satellite positioning of user equipment (UE) from the UE; in response to receiving the first information related to the satellite positioning, transmitting assistance information related to the satellite positioning to the UE, wherein the assistance information includes information for the satellite positioning of the UE related to at least one satellite other than a serving satellite of the UE, wherein the assistance information is used to determine uplink transmit timing.

In an implementation, wherein the assistance information includes at least one of information on an additional positioning reference signal related to the at least one satellite, system information of the at least one satellite, and ephemeris information of the at least one satellite.

In an implementation, wherein the first information related to the satellite positioning includes at least one of information on a satellite positioning capability, information on a satellite positioning error, and information on a satellite positioning request.

In an implementation, wherein the information on the satellite positioning capability is included in UE capability information, and the information on the satellite positioning error and/or the information on the satellite positioning request is included in a radio resource control (RRC) establishment request.

In an implementation, wherein an initial transmission timing error requirement that the uplink transmit timing needs to meet corresponds to a satellite positioning accuracy related information of the UE.

According to an embodiment of the present disclosure, there is provided a method performed by user equipment (UE) in a communication system, comprising: transmitting a physical random access channel (PRACH) to a base station based on second information related to a first positioning capability of the UE; receiving a random access response (RAR) from the base station, wherein a size of the number of information bits of an uplink timing advance (TA) included in the RAR corresponds to the second information, and/or an adjustment granularity of the TA included in the RAR corresponds to the second information.

In an implementation, wherein the second information includes whether the UE supports the first positioning capability, and transmitting the physical random access channel (PRACH) to the base station based on the second information related to the first positioning capability of the UE comprises: transmitting, by a UE that does not support the first positioning capability, a PRACH in a first PRACH format to the base station; transmitting, by a UE that supports the first positioning capability, a PRACH in a second PRACH format to the base station.

In an implementation, wherein the second information includes information related to a first positioning accuracy of the UE, and transmitting the physical random access channel (PRACH) to the base station based on the second information related to the first positioning capability of the UE comprises: transmitting, by a UE having the first positioning capability with a first accuracy, a PRACH to the base station based on a first PRACH resource pool; transmitting, by a UE having the first positioning capability with a second accuracy, a PRACH to the base station based on a second PRACH resource pool.

In an implementation, wherein the first PRACH resource pool and the second PRACH resource pool are distinguished by at least one of PRACH time domain resources, PRACH frequency domain resources and PRACH preambles.

According to an embodiment of the present disclosure, there is provided a method performed by a base station in a communication system, comprising:

receiving a PRACH from user equipment (UE), wherein the PRACH implies second information related to a first positioning capability of the UE; transmitting a RAR to the UE, wherein a size of the number of information bits of a TA included in the RAR corresponds to the second information, and/or an adjustment granularity of the TA included in the RAR corresponds to the second information.

In an implementation, wherein the second information includes whether the UE supports the first positioning capability or information related to a first positioning accuracy of the UE.

According to an embodiment of the present disclosure, there is provided a device in a communication system, comprising: a transceiver; and a controller coupled with the transceiver and configured to perform controls so that the device performs the method according to embodiments of the present disclosure.

The above-described various embodiments of the disclosure are merely some of the preferred embodiments of the disclosure, and various embodiments reflecting the technical features of the disclosure may be derived and understood by those skilled in the art based on the following detailed description of the disclosure.

### Advantageous Effects of Invention

The present disclosure may provide a method and device for determining uplink transmit timing in satellite communication.

The effects that can be achieved through the disclosure are not limited to the effects mentioned in the various embodiments, and other effects not mentioned will be clearly understood by those skilled in the art from the description below.

### BRIEF DESCRIPTION OF DRAWINGS

FIG. 1 illustrates an example wireless network according to various embodiments of the present disclosure;

FIG. 2a illustrates an example wireless transmission path according to the present disclosure;

FIG. 2b illustrates an example wireless reception path according to the present disclosure;

FIG. 3a illustrates an example UE according to the present disclosure;

FIG. 3b illustrates an example gNB according to the present disclosure;

FIG. 4 illustrates a schematic diagram related to timing between gNB and UE;

FIG. 5 illustrates a schematic diagram of a satellite communication system;

FIG. 6 illustrates a schematic diagram of a satellite communication system in frequency band 1 (FR1) of 5G;

FIG. 7 illustrates a schematic diagram of a positioning error of a UE in a satellite communication system;

FIG. 8 illustrates an example communication flow in a satellite communication system;

FIG. 9 illustrates a schematic diagram of an example method according to an embodiment of the present disclosure;

FIG. 10 illustrates a schematic diagram of an example method according to an embodiment of the present disclosure;

FIG. 11 illustrates an example hardware block diagram of a device according to the present disclosure.

### MODE FOR THE INVENTION

The following description with reference to the accompanying drawings is provided to facilitate a comprehensive understanding of various embodiments of the disclosure as defined by the claims and their equivalents. This description includes various specific details to facilitate understanding but should only be considered as exemplary. Therefore, those skilled in the art will recognize that various changes and modifications may be made to the various embodiments described herein without departing from the scope and spirit of the disclosure. In addition, for the sake of clarity and conciseness, descriptions of well-known functions and structures may be omitted.

The terms and expressions used in the following specification and claims are not limited to their dictionary meanings, but are only used by the inventors to enable a clear and consistent understanding of the disclosure. Therefore, it should be obvious to those skilled in the art that the following descriptions of various embodiments of the disclosure are provided for illustration purposes only and are not intended to limit the purposes of the disclosure as defined in the appended claims and their equivalents.

It should be understood that singular forms of “a”, “an” and “the” include plural referents unless the context clearly indicates otherwise. Thus, for example, a reference to a “component surface” includes a reference to one or more such surfaces.

The terms “include” or “may include” refer to the existence of a corresponding disclosed function, operation or component that may be used in various embodiments of the disclosure, without limiting the existence of one or more additional functions, operations or features. In addition, the terms “include” or “have” may be interpreted as indicating certain characteristics, numbers, steps, operations, constituent elements, components or combinations thereof, but should not be interpreted as excluding the possibility of the existence of one or more other characteristics, numbers, steps, operations, constituent elements, components or combinations thereof.

The term “or” used in various embodiments of the disclosure includes any of the listed terms and all combinations thereof. For example, “A or B” may include A, may include B, or may include both A and B.

Unless defined differently, all terms (including technical terms or scientific terms) used in this disclosure have the same meaning as those understood by those skilled in the art in this disclosure. General terms, as defined in dictionaries, are interpreted as having meanings consistent with the context in relevant technical fields, and should not be interpreted in an idealized or overly formal way unless explicitly defined in this disclosure.

The technical solutions of the embodiment of the application can be applied to various communication systems, for example, the Global System for Mobile Communications (GSM) system, the code division multiple access (CDMA) system, the wideband code division multiple access (WCDMA) system, the general packet radio service (GPRS), the long term evolution (LTE) system, the LTE frequency division duplex (FDD) system, the LTE time division duplex (TDD), the universal mobile telecommunications system (UMTS), the worldwide interoperability for microwave access (WiMAX) communication system, the 5th generation (5G) system or new radio (NR), etc. In addition, the technical solutions of the embodiment of the application can be applied to future-oriented communication technologies.

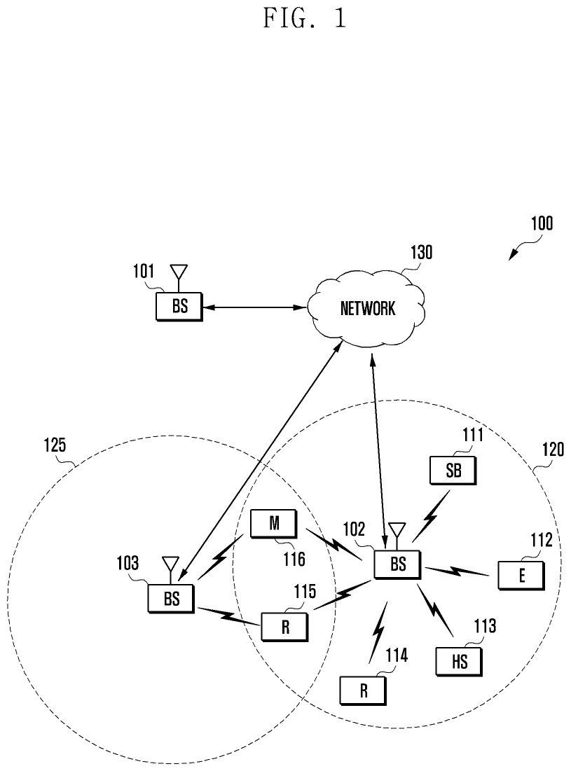

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

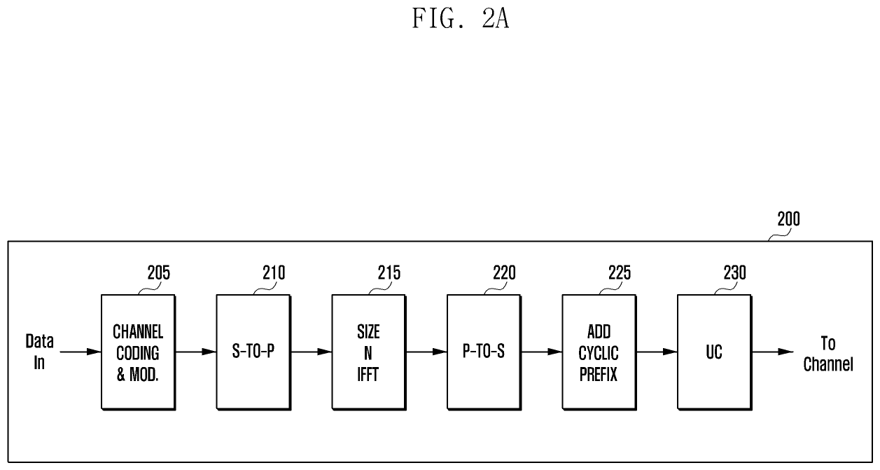

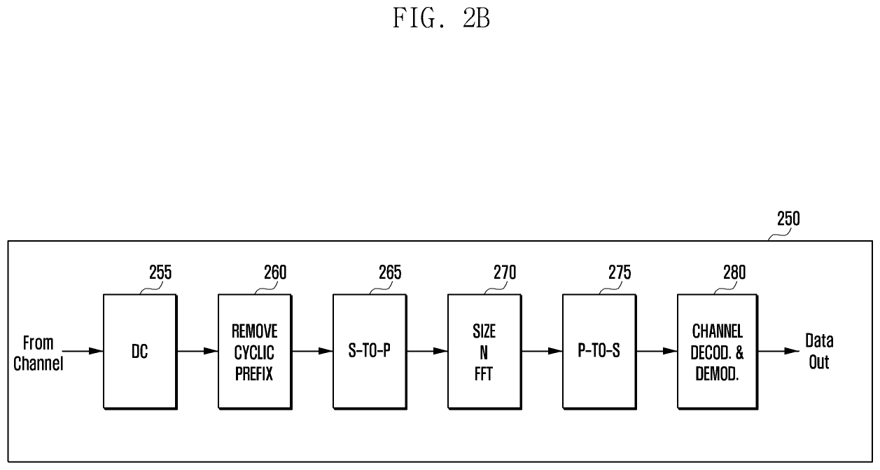

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The upconverter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

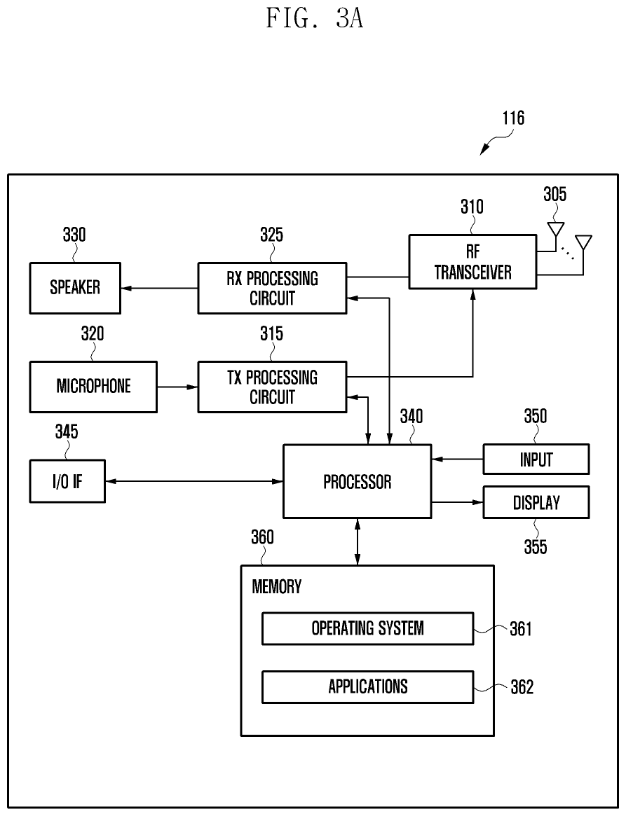

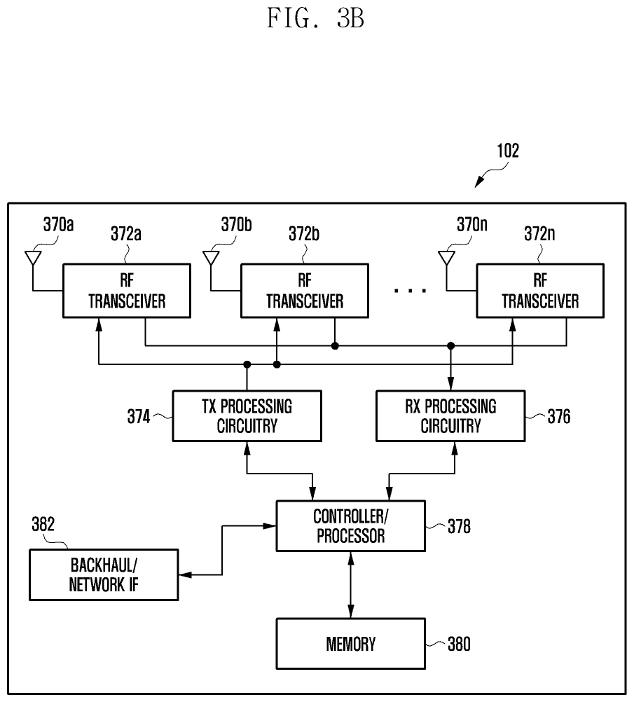

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The exemplary embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

With the development of 5G system, in order to provide users with better communication services, such as at any time and any place, especially in mountainous areas and marine coverage areas, etc., because the satellite communication system has the advantages of longer communication distance and larger coverage area, the support of the satellite communication has been introduced in 5G communication system. According to the types and orbital heights of satellites, satellite communication systems can be divided into geosynchronous earth orbit (GEO for short) and non-geostationary satellite systems. Among the non-geostationary satellites, according to their orbital heights, they can be divided into Medium Earth Orbit (MEO for short) satellite system and Low Earth Orbit (LEO for short) satellite system.

In LTE or 5G communication systems, whether it is terrestrial communication system or satellite communication system, the uplink adopts single carrier frequency division (SC-FDMA) or CP-OFDMA multiple access technology, and these multiple access technologies require that the uplink signals of different user terminals UEs arrive at the base station basically at the same time, and the time difference between the uplink signals of multiple user terminals UEs arriving at the base station is not greater than the length of cyclic prefix (CP), so as to ensure the orthogonality among multiple user terminals UEs, otherwise, there will be interference among multiple users at the base station, and the uplink data of each terminal UE cannot be guaranteed. Therefore, in both LTE and 5G NR terrestrial wireless communication systems, there are corresponding timing mechanisms to ensure the orthogonality of multiple users at the base station. The specific mechanism is as follows: according to the downlink timing of the base station to the terminal, the uplink transmit timing is limited and adjusted as follows.

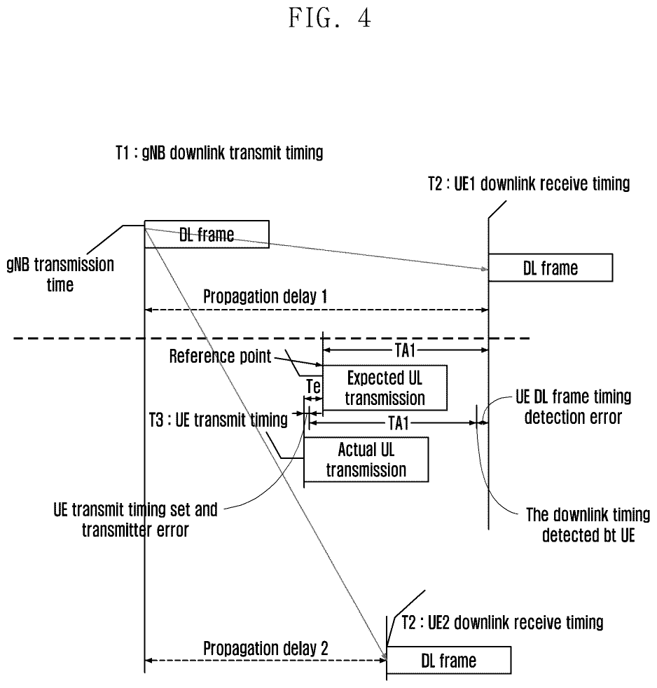

First of all, the uplink frame (or uplink signal) transmit timing at the UE side needs to refer to the receiving time point of the downlink frame (or downlink signal) received at the UE side. As shown in FIG. 4, the base station transmits a downlink frame at time T1. When the downlink signal is received by the UE at time point T2 after the time delay of T_{Propagation_delay}, the reference point of downlink timing is obtained. The UE transmits an uplink signal at time T3, and the transmit timing has TA (Timing Advance) relative to the downlink timing, which is related to the distance between the UE and the base station. The base station separately performs uplink estimation for each UE to adjust the TA of each UE. In the existing terrestrial communication system, the TA includes two parts: N_{TA} and N_{TA_offset}. N_{TA_offset} is the timing advance offset provided by the serving cell. If the serving cell is not configured for UE, it is a default value determined according to the system and frequency band. N_{TA} is delivered to UE through MAC signaling after estimating the PRACH of each user by the base station. Due to the error of the downlink timing detection module and the configuration of the uplink transmission chain, there is a certain error between the actual transmission time point and the ideal uplink transmission time point, but the initial transmission timing error of the UE must be less than or equal to ±Tₑ seconds, the details are shown in Table 1 below:

TABLE 1

| frequency | SCS of SSB signal | SCS of uplink | |
|---|---|---|---|
| range | (kHz) | signal (kHz) | Tₑ |
| 1 | 15 | 15 | 12*64*T_{c} |
| | | 30 | 10*64*T_{c} |
| | | 60 | 10*64*T_{c} |
| | 30 | 15 | 8*64*T_{c} |
| | | 30 | 8*64*T_{c} |
| | | 60 | 7*64*T_{c} |
| 2-1 | 120 | 60 | 3.5*64*T_{c} |
| | | 120 | 3.5*64*T_{c} |
| | 240 | 60 | 3*64*T_{c} |
| | | 120 | 3*64*T_{c} |

Herein in Table 1, Tc=1/(480*1000*4096) seconds.

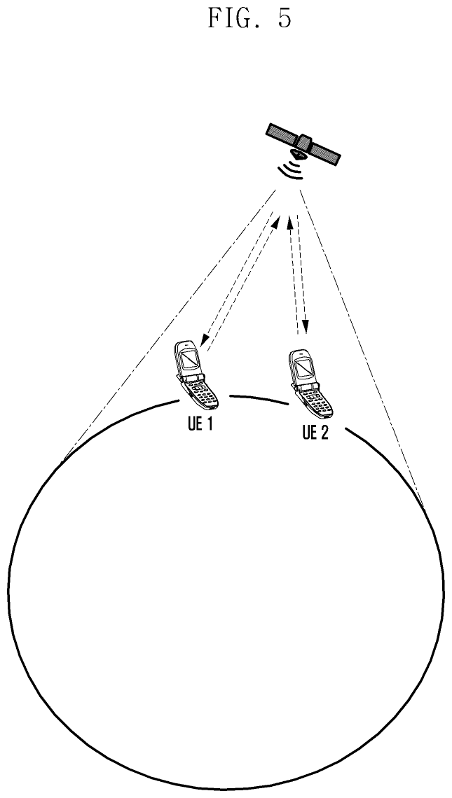

The biggest difference between the satellite communication system and the terrestrial communication system is that the physical distance between the satellite and the terminal is huge, which leads to a long Round Trip Time, as shown in FIG. 5.

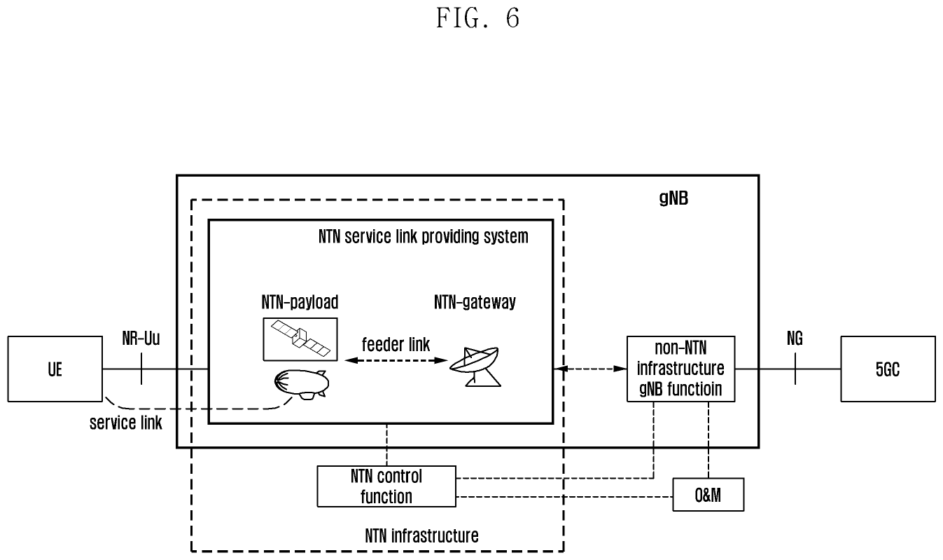

In the satellite communication system of 5G frequency band 1 (FR1), as shown in FIG. 6, the communication between the gateway and the satellite is via a feeder link. The communication between the UE and the satellite is via a service link. The UE still adopts the scheme of uplink timing advance. However, compared with terrestrial communication system, the technical solution of UE pre-compensation is introduced. The consideration of delay of the feeder link and the service link is taken into the TA, and the specific formula is as follows:

$${T}_{TA} = ( {N}_{TA} + {N}_{TA , offset} + {N}_{TA , adj}^{common} + {N}_{TA , adj}^{UE} ) {T}_{C}$$

The UE compensates

$${N}_{TA , adj}^{common}$$

by the system assistance information TACommon, TACommonDrift and TACommonDriftVariation. The UE estimates

$${N}_{TA , adj}^{UE}$$

by its own GNSS (Global Navigation Satellite Systems) positioning system and ephemeris information of service satellites. Finally, the uplink transmit timing of the UE is obtained, as shown in the following table 2:

TABLE 2

| frequency | SCS of SSB | SCS of uplink | |
|---|---|---|---|
| range | signal (kHz) | signal (kHz) | Te_NTN |
| 1 | 15 | 15 | 29*64*Tc |
| | | 30 | 24*64*Tc |
| | | 60 | N/A |
| | 30 | 15 | 24*64*Tc |
| | | 30 | 22*64*Tc |
| | | 60 | N/A |

In this solution, the UE needs to have the capability of the GNSS (Global Navigation Satellite Systems) positioning.

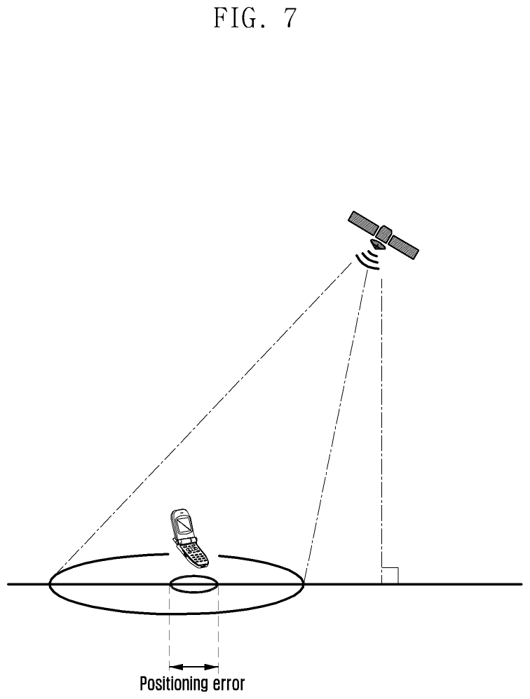

However, the disadvantage of the above technical solution is that, as shown in FIG. 7, in the satellite communication system, the positioning error of UE cannot be ignored in the initial transmit timing. If the frequency band is low, such as below 6 GHz, the SCS adopts 15 kHz or 30 kHz, and the total time error can still be controlled within the maximum tolerance according to the GNSS positioning error of 50 m. The maximum tolerance is

$$\frac{{T}_{cp} - {T}_{chdelay}}{2}$$

among which, T_{cp} is the time length of the uplink CP, T_{chdelay} is the maximum delay of the channel. Then the existing mechanism can still work. However, when the SCS adopts a larger spacing, such as 60 kHz/120 kHz/240 kHz or more, or the GNSS positioning error of UE is worse, the initial transmit timing may exceed the maximum tolerance. For example, when SCS=120 kHz, the Te of the terrestrial communication system is 3.5*64*Tc, and the Te is about 0.11 microsecond. The length of CP is about 0.57 microseconds. Taking the positioning error of the GNSS of 50 m as an example, the time difference caused by the positioning error of the UE is about 0.33 microseconds, which brings great challenges to the base station for the multi-user reception, and the interference between multiusers cannot be avoided and the performance cannot be guaranteed.

The invention proposes how to adjust the uplink transmit timing at the UE side. The implemented communication method includes: firstly, the UE reports first information related to satellite positioning to the base station side, for example, the first information related to the satellite positioning may include at least one of the following items: a) the positioning capability of the UE, b) the additional positioning request information of the UE, or c) the error related information of the UE positioning (for example, the size and type of the positioning error, etc.), and the base station performs different network configurations according to the first information related to satellite positioning reported by the UE (for example, a) the positioning capability of the UE, or b) the additional positioning request information of the UE, or c) the error related information of the UE positioning (for example, the size and type of the positioning error, etc.)), and if necessary, simultaneously transmits information of system positioning reference signal and assistance information for positioning (including but not limited to a list of other satellites which are non-serving satellites required for positioning, and the corresponding system information and/or ephemeris information thereof), and the UE performs corresponding receiver processing according to the assistance information provided by the system.

As mentioned above, when the uplink transmit timing requirement cannot be met in the satellite system, the present disclosure provides a solution to at least the above problems:

When the uplink transmit timing requirement cannot be met in the satellite system, a new signaling interaction process between the terminal device UE and the base station is proposed, and different signaling interaction mechanisms and processing at UE receiver are carried out for a) the positioning capability of the UE, or b) the additional positioning request information of the UE, or c) the error related information of the UE positioning.

According to the report of the UE, the base station decides whether to add additional positioning information to assist the UE to adjust the uplink timing.

The application provides a communication method, terminal equipment and a base station of the satellite system, which are used for ensuring the performance of a multiuser receiver.

According to an exemplary embodiment of the present disclosure, there is provided a communication method jointly performed by a base station and a terminal device: the terminal device reports to the base station a) the positioning capability of the UE, or b) the additional positioning request information of the UE, or c) the error related information of the UE positioning, and the base station judges according to the report of the UE and provides system assistance information, and the terminal device performs timing compensation based on the receiver processing performed based on the system assistance information provided by the network to ensure that the difference between arriving time of multi-users at the base station is still within CP, so as to eliminate multi-users interference.

In the satellite system, a communication system with a timing scheme for reducing multi-user interference comprises the following specific procedures:
The UE reports at least one of a) the positioning capability of the UE, or b) the additional positioning request information of the UE, or c) the error related information of the UE positioning;
The base station provides different system assistance information based on the report of the UE;
The UE performs the processing at the receiver and adjusts the transmit timing of the uplink signal, based on the assistance information provided by the network.

For example, if, based on the report of the UE, the base station recognizes that the positioning capability of the UE is insufficient, or the positioning error does not meet the corresponding positioning accuracy requirements, or the UE needs additional positioning, the base station can transmit assistance information that can be used to assist the UE in more accurate positioning. The assistance information may include, for example, information on one or more other satellites (which may also be called non-serving satellites) other than the serving satellites of the UE, so that the UE can perform more accurate positioning based on the one or more other satellites according to the assistance information. Alternatively, the assistance information may include information of additional positioning reference signal, so that the UE can achieve more accurate positioning through additional positioning reference signals.

In one implementation, the assistance information transmitted by the base station to the UE may include system information and/or ephemeris information of the one or more non-serving satellites, or information on additional positioning reference signals, so that the UE can implement more accurate positioning based on the one or more non-serving satellites or the additional positioning reference signals, such that the UE can better pre-compensate the uplink transmit timing, so that the UE can obtain a more suitable uplink transmit timing.

According to the embodiment of the present disclosure, the UE may also receive assistance information for positioning periodically transmitted by the base station. The UE receiving the assistance information can determine whether to use the assistance information for positioning and adjust the uplink transmit timing based on the positioning capability of the UE (for example, the satellite positioning capability such as the GNSS positioning capability). For example, according to the positioning capability of the UE, the UE may be one of a plurality of types (e.g., but not limited to, Type 1 UE and Type 2 UE).

Taking the UE as one of Type 1 UE and Type 2 UE as an example, the Type 1 UE may represent that the UE has a positioning capability with high accuracy (for example, not lower than a certain accuracy threshold), or the UE has no additional positioning requests, or the positioning error of the UE is within the set or configured threshold, or the positioning error type of the UE is a set or configured type; the Type 2 UE may represent that the UE has a positioning capability with low accuracy (for example, lower than a certain accuracy threshold), or the UE has additional positioning requests, or the positioning error of the UE exceeds the set or configured threshold, or the positioning error type of the UE is a set or configured type.

When receiving the assistance information transmitted by the base station, the Type 1 UE may ignore the assistance information, and the Type 2 UE may perform additional positioning using the indicated additional positioning reference signal based on the assistance information, or perform additional positioning based on the information of the indicated non-serving satellite, so as to obtain more accurate positioning information. Thus, the UE can adjust the uplink transmit timing based on the obtained more accurate positioning information.

Alternatively, information on the type of UE can also be reported to the base station, so that the base station can match different network configuration measurement information based on the type of UE. For example, based on the type reported by the UE, the base station can perform the following operations:
If it is determined based on the UE type that the reporting UE is a UE with a positioning capability of high accuracy or the additional positioning request information of the UE is no, the base station does not need to provide the assistance information.
If it is determined based on the UE type that the reporting UE is a UE with a low positioning capability or the additional positioning request information of the UE is yes, the base station needs to provide the assistance information, such as the downlink positioning reference signals transmitted by the base station and the system information and/or ephemeris information of other satellites required for positioning.

For the Type 2 UE, when receiving the assistance information, more accurate positioning can be achieved according to the assistance information. The specific operation is as described above and will not be repeated here.

The technical solution of the embodiment of the application can be applied to various satellite types, including but not limited to LEO, MEO, HEO, LEO, HAPS, and various beam deployment schemes, including but not limited to Fixed Beams and Earth Moving Beams.

In one implementation, information on the positioning capability of the UE can be added in the UECapabilityInformation or information on the additional positioning request of the U can be added in the RRCsetupRequest. In the downlink configuration, information on the list of other satellites required for positioning can be added, including system information and/or ephemeris information of the satellites in the list.

In one implementation, according to the UE transmit timing requirements, two different series of requirements can be specified according to the different positioning capabilities or additional positioning requests of the UE or the UE type for positioning.

When the positioning capability is a UE with a low accuracy or the additional positioning request information of the UE is yes, or the UE type is the above-mentioned Type 2 UE, the Te requirements (the threshold that the difference between the actual transmit timing and the ideal transmit timing needs to meet) are shown in Table 3:

TABLE 3

| frequency | SCS of SSB | SCS of uplink | |
|---|---|---|---|
| range | signal (kHz) | signal(kHz) | Te_NTN |
| 1 | 15 | 15 | X₁*64*T_{c} |
| | | 30 | X₂*64*T_{c} |
| | | 60 | X₃*64*T_{c} |
| | 30 | 15 | X₄*64*T_{c} |
| | | 30 | X₅*64*T_{c} |
| | | 60 | X₆*64*T_{c} |
| 2-1 | 120 | 60 | X₇ *64*T_{c} |
| | | 120 | X₈ *64*T_{c} |
| | 240 | 60 | X₉ *64*T_{c} |
| | | 120 | X₁₀ *64*T_{c} |

Among them, the values of the parameters in Table 3 can be, for example, the value range of X1 is [13, 17]; the value range of X2 is [11, 16]; the value range of X3 is [11, 16]; the value range of X4 is [9,13]; the value range of X5 is [9,13]; the value range of X6 is [8,13]; the value range of X7 is [4,9]; the value range of X8 is [4,9]; the value range of X9 is [4,9]; the value range of X10 is [4, 9].

However, when UE with a positioning capability of high accuracy or the additional positioning request information of the UE is no, or the UE type is the above-mentioned Type 1 UE, the Te requirements are shown in Table 4:

TABLE 4

| frequency | SCS (kHz) of | SCS (kHz) of | |
|---|---|---|---|
| range | SSB signal | uplink signal | Te_NTN |
| 1 | 15 | 15 | X₁₁*64*T_{c} |
| | | 30 | X₁₂*64*T_{c} |
| | | 60 | X₁₃*64*T_{c} |
| | 30 | 15 | X₁₄*64*T_{c} |
| | | 30 | X₁₅*64*T_{c} |
| | | 60 | X₁₆*64*T_{c} |
| 2-1 | 120 | 60 | X₁₇ *64*T_{c} |
| | | 120 | X₁₈ *64*T_{c} |
| | 240 | 60 | X₁₉ *64*T_{c} |
| | | 120 | X₂₀ *64*T_{c} |

Among them, the values of the parameters in Table 4 can be, for example: the value range of X11 is [13,20]; the value range of X12 is [11, 17]; the value range of X13 is [11, 17]; the value range of X14 is [9,16]; the value range of X15 is [9,16]; the value range of X16 is [8,15]; the value range of X17 is [4,10]; the value range of X18 is [4,9]; the value range of X19 is [4,9]; the value range of X20 is [4, 9].

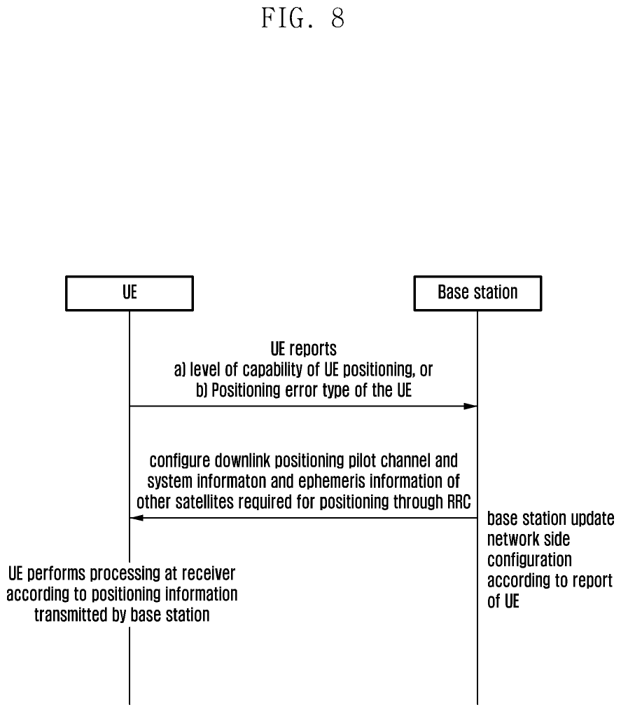

FIG. 8 illustrates an example communication procedure in a satellite communication system. As shown in FIG. 8, the procedure of the communication system is designed as follows:

1) firstly, the UE reports first information related to the satellite positioning of the UE to the base station, including, for example, a) the positioning capability of the UE, or b) the additional positioning request information of the UE, or c) the error related information of the UE positioning (for example, the size and type of the positioning error, etc.).

The first information related to satellite positioning reported by UE can be divided into the following categories:
Type 1: if UE is with a high positioning capability or the additional positioning request information of the UE is no, the system doesn't need to provide any assistance information.
Type 2: if UE is with a low positioning capability or the additional positioning request information of the UE is yes, the system needs to provide other assistance information, including but not limited to downlink positioning reference signals transmitted by the base station, system information and ephemeris information of other satellites required for positioning.

2) The base station decides whether to provide other system assistance information based on the report of the UE.
Type 1: if UE is with a high positioning capability or the additional positioning request information of the UE is no, the system doesn't provide any assistance information.
Type 2: if UE is with a low positioning capability or the additional positioning request information of the UE is yes, the base station configures, including but not limited to, for example downlink positioning reference signal transmitted by the base station, system information and ephemeris information of other satellites required for positioning.

3) UE performs different processing at receiver based on the system configuration information of the network, and transmits the uplink signal after timing compensation and adjustment.

In an alternative, two types of UE are supported in the NTN system: a first UE without a GNSS positioning capability and a second UE with a GNSS positioning capability. Because the first UE does not have the GNSS positioning capability, the first UE cannot estimate the distance between itself and the satellite base station, so it cannot estimate the time offset and/or frequency offset of wireless signal transmission between the UE and the satellite base station, so it cannot pre-compensate the time offset and/or frequency offset of the uplink signal, which requires the PRACH signal to support a larger range of detectable time-frequency offset, and the existing PRACH signal needs to be enhanced. For example, a new PRACH format is defined for the first UE, and the new PRACH format may have a longer preamble sequence, a longer Cyclic Prefix (CP), a longer guard interval (Gap), and/or use a larger preamble orthogonal width (a cyclic offset Ncs for generating all orthogonal sequences from the same root sequence). Because the second UE has the GNSS positioning capability, the second UE can estimate the distance between itself and the satellite base station, so as to estimate the time offset and/or frequency offset of wireless signal transmission between the UE and the satellite base station, so as to pre-compensate the uplink signal for the time offset and/or frequency offset, so as to reuse the existing PRACH signal. Therefore, different PRACH signals can be used to access the network for these two UEs with different capabilities, so as to provide better system performance.

In addition, for the first UE and the second UE, the indication field size and/or the adjustment granularity of the timing advance TA indicated in the corresponding random access response (RAR) may also be different. For example, for the first UE, the TA indicated in the RAR can use more indication bits and/or larger adjustment granularity, thus achieving a larger TA indication range. The existing TA indication field in the RAR is 12 bits, and for the first UE, the TA indication field in the RAR can 2^{μ}·15 kHz, the existing adjustment granularity of TA indicated in RAR is 16·64·T_{c}/2^{μ}. For the first UE, the adjustment granularity of TA can be expanded to 32·64·T_{c}/2^{μ} or 64·64·T_{c}/2^{μ}, etc. Similarly, after the first UE enters the RRC connected state, it can also use more indication bits and/or larger adjustment granularity of TA for the received TA command MAC CE and absolute TA command MAC CE. For example, the 6-bit TA indication field in the existing TA command MAC CE can be expanded to 8 or 10 bits, etc., the 12-bit TA indication field in the existing absolute TA command MAC CE can be expanded to 14 or 18 bits, etc., and the existing TA adjustment granularity of 16·64·T_{c}/2^{μ} can be expanded to 32·64·T_{c}/2^{μ} or 64·64·T_{c}/2^{μ}, etc.

This alternative can be summarized as including at least one of the following:
according to whether the UE supports the GNSS positioning capability, selecting a corresponding PRACH format to transmit the PRACH;
receiving a RAR, wherein a size of the number of information bits of TA and/or an adjustment granularity of the TA indicated in the RAR are related to whether the UE supports the GNSS positioning capability;
receiving a TA command MAC CE or an absolute TA command MAC CE, wherein a size of the number of information bits of TA and/or am adjustment granularity of the TA indicated in the TA command MAC CE or the absolute TA command MAC CE are related to whether the UE supports the GNSS positioning capability.

It should be understood that this alternative can be performed independently or in any suitable combination with the methods involved in other embodiments or solutions in this disclosure. For example, the method in this alternative may be performed after the method involved in the aforementioned embodiment, but it may not be limited to this.

In an alternative, at least two UE capabilities related to the GNSS positioning accuracy are supported in the NTN system: a UE with a low GNSS positioning accuracy and a UE with a high GNSS positioning accuracy. For example, the third UE has a low accuracy GNSS positioning capability, and due to the low accuracy of the GNSS positioning, the third UE has a large estimation error of the distance between itself and the satellite base station, and the estimation accuracy of the time offset and/or frequency offset of wireless signal transmission between the UE and the satellite base station is low, so that it is impossible to pre-compensate the uplink signal for the time offset and/or frequency offset more accurately; the fourth UE has a GNSS positioning capability of high accuracy. Because of the high accuracy of GNSS positioning, the fourth UE estimates the distance between itself and the satellite base station more accurately, and estimates the time offset and/or frequency offset of wireless signal transmission between the UE and the satellite base station more accurately, so that the uplink signal can be pre-compensated more accurately for the time offset and/or frequency offset. The UE can implicitly report the capability of a corresponding GNSS positioning accuracy to the network by using different PRACH resources. For example, UEs with capabilities of different GNSS positioning accuracy use different PRACH resources, where different PRACH resources include different PRACH time domain resources, different PRACH frequency domain resources, and/or different PRACH preambles.

In addition, for the third UE and the fourth UE, the indication field size and/or adjustment granularity of the TA indicated in the corresponding RAR may also be different. For example, the third UE needs a larger TA indication range and/or a larger TA adjustment granularity than the fourth UE, assuming that the fourth UE uses the existing TA indication field size (12 bits) and the existing TA adjustment granularity (16·64·T_{c}/2^{μ}), the third UE can use TA indication field of a larger size such as 14 or 16 bits, etc., and/or use a larger TA adjustment granularity such as 32·64·T_{c}/2^{μ} or 64·64·T_{c}/2^{μ}, etc. Similarly, after the third UE enters the RRC connected state, it can also use more TA indication bits and/or larger TA adjustment granularity for the received TA command MAC CE and the absolute TA command MAC CE. For example, the 6-bit TA indication field in the existing TA command MAC CE can be expanded to 8 or 10 bits, etc., the 12-bit TA indication field in the existing absolute MAC CE can be expanded to 14 or 18 bits, etc., and the existing TA adjustment granularity of 16·64·T_{c}/2^{μ} be expanded to 32·64·T_{c}/2^{μ} or 64·64·T_{c}/2^{μ} etc.

This alternative can be summarized as including at least one of the following:
according to the capability of the UE related to the GNSS positioning accuracy, selecting a corresponding PRACH resources to transmit PRACH;
receiving a RAR, wherein a size of the number of information bits and/or an adjustment granularity of the TA indicated in the RAR are related to the GNSS positioning accuracy of the UE;
receiving a TA command MAC CE or an absolute TA command MAC CE, wherein a size of the number of information bits and/or an adjustment granularity of the TA indicated in the TA command MAC CE or the absolute TA command MAC CE are related to the GNSS positioning accuracy of the UE.

It should be understood that this alternative can be performed independently or in any suitable combination with the methods involved in other embodiments or solutions in this disclosure. For example, the method in this alternative may be performed after the method involved in the aforementioned embodiment, but it may not be limited to this.

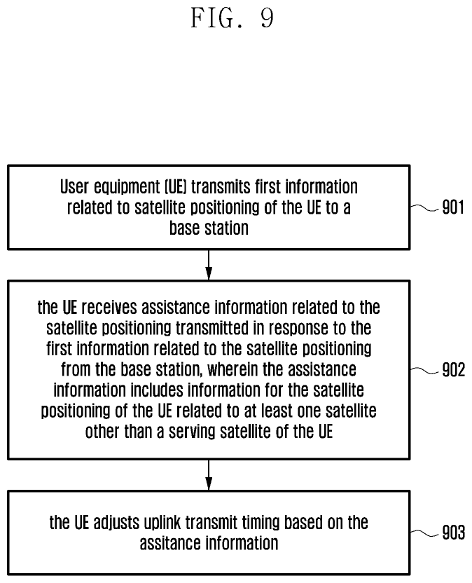

FIG. 9 illustrates a schematic diagram of an example method 900 according to an embodiment of the present disclosure.

As shown in FIG. 9, the method 900 includes the following steps:

Step 901: User equipment UE transmits first information related to satellite positioning of the UE to a base station;

Step 902: The UE receives assistance information related to the satellite positioning transmitted in response to the first information related to the satellite positioning from the base station, wherein the assistance information includes information for the satellite positioning of the UE related to at least one satellite other than a serving satellite of the UE; and

Step 903: The UE adjusts uplink transmit timing based on the assistance information.

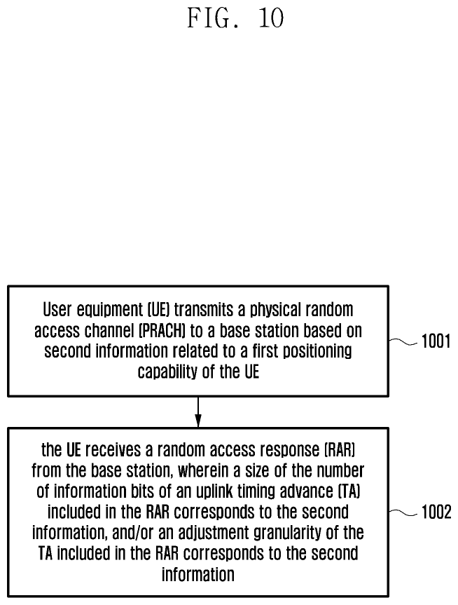

FIG. 10 illustrates a schematic diagram of an example method 1000 according to an embodiment of the present disclosure.

As shown in FIG. 10, the method 1000 includes the following steps:

Step 1001: User equipment UE transmits a physical random access channel (PRACH) to a base station based on second information related to a first positioning capability of the UE;

Step 1002: The UE receives a random access response (RAR) from the base station, wherein a size of the number of information bits of an uplink timing advance (TA) included in the RAR corresponds to the second information, and/or an adjustment granularity of the TA included in the RAR corresponds to the second information.

According to an embodiment of the disclosure, a method performed by user equipment (UE) in a communication system, the method including: transmitting first information related to satellite positioning of the UE to a base station; receiving assistance information related to the satellite positioning transmitted in response to the first information related to the satellite positioning from the base station, wherein the assistance information includes information for the satellite positioning of the UE related to at least one satellite other than a serving satellite of the UE; and adjusting uplink transmit timing based on the assistance information.

According to an embodiment of the disclosure, the assistance information includes at least one of information on an additional positioning reference signal related to the at least one satellite, system information of the at least one satellite, and ephemeris information of the at least one satellite.

According to an embodiment of the disclosure, the first information related to the satellite positioning includes at least one of information on a satellite positioning capability, information on a satellite positioning error, and information on a satellite positioning request.

According to an embodiment of the disclosure, the information on the satellite positioning capability is included in UE capability information, and at least one of the information on the satellite positioning error or the information on the satellite positioning request is included in a radio resource control (RRC) establishment request.

According to an embodiment of the disclosure, an initial transmission timing error requirement that the uplink transmit timing needs to meet corresponds to a satellite positioning accuracy related information of the UE.

According to an embodiment of the disclosure, a method performed by a base station in a communication system, the method including: receiving first information related to satellite positioning of user equipment (UE) from the UE; transmitting assistance information related to the satellite positioning to the UE based on the first information related to the satellite positioning, wherein the assistance information includes information for the satellite positioning of the UE related to at least one satellite other than a serving satellite of the UE, wherein the assistance information is used to determine uplink transmit timing.

According to an embodiment of the disclosure, the assistance information includes at least one of information on an additional positioning reference signal related to the at least one satellite, system information of the at least one satellite, and ephemeris information of the at least one satellite.

According to an embodiment of the disclosure, the first information related to the satellite positioning includes at least one of information on a satellite positioning capability, information on a satellite positioning error, and information on a satellite positioning request.

According to an embodiment of the disclosure, the information on the satellite positioning capability is included in UE capability information, and at least one of the information on the satellite positioning error or the information on the satellite positioning request is included in a radio resource control (RRC) establishment request.

According to an embodiment of the disclosure, wherein an initial transmission timing error requirement that the uplink transmit timing needs to meet corresponds to a satellite positioning accuracy related information of the UE.

According to an embodiment of the disclosure, a method performed by user equipment (UEL) in a communication system, the method including: transmitting a physical random access channel (PRACH) to a base station based on second information related to a first positioning capability of the UE; receiving a random access response (RAR) from the base station, wherein a size of a number of information bits of an uplink timing advance (TA) included in the RAR corresponds to the second information, and/or an adjustment granularity of the TA included in the RAR corresponds to the second information.

According to an embodiment of the disclosure, the second information includes whether the UE supports the first positioning capability.

According to an embodiment of the disclosure, transmitting the physical random access channel (PRACH) to the base station based on the second information related to the first positioning capability of the UE includes: transmitting, by a UE that does not support the first positioning capability, a PRACH in a first PRACH format to the base station; and transmitting, by a UE that supports the first positioning capability, a PRACH in a second PRACH format to the base station.

According to an embodiment of the disclosure, the second information includes information related to a first positioning accuracy of the UE.

According to an embodiment of the disclosure, transmitting the physical random access channel (PRACH) to the base station based on the second information related to the first positioning capability of the UE includes: transmitting, by a UE having the first positioning capability with a first accuracy, a PRACH to the base station based on a first PRACH resource pool; and transmitting, by a UE having the first positioning capability with a second accuracy, a PRACH to the base station based on a second PRACH resource pool.

According to an embodiment of the disclosure, the first PRACH resource pool and the second PRACH resource pool are distinguished by at least one of PRACH time domain resources, PRACH frequency domain resources and PRACH preambles.

According to an embodiment of the disclosure, a method performed by a base station in a communication system, the method including: receiving a PRACH from user equipment (UE), wherein the PRACH implies second information related to a first positioning capability of the UE; transmitting a RAR to the UE, wherein a size of a number of information bits of a TA included in the RAR corresponds to the second information, and/or an adjustment granularity of the TA included in the RAR corresponds to the second information.

According to an embodiment of the disclosure, the second information includes whether the UE supports the first positioning capability or information related to a first positioning accuracy of the UE.

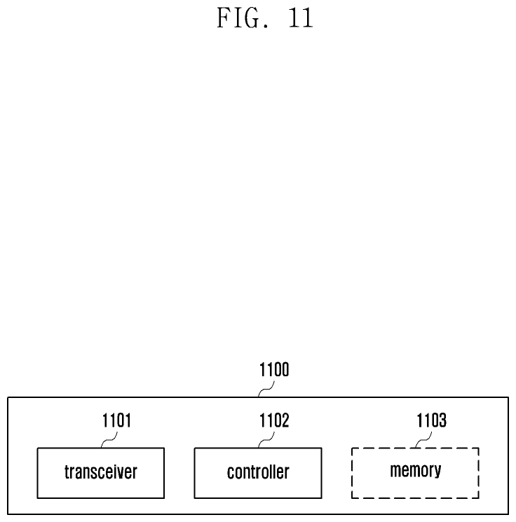

FIG. 11 illustrates a schematic block diagram of a device 1100 according to various embodiments of the present disclosure, which may be configured to implement any one or more of the methods according to various embodiments of the present disclosure. Therefore, the device 1100 can be user equipment UE or a base station described in this disclosure, or any other device suitable for performing the method of this disclosure.

As shown in FIG. 11, the device 1100 includes a transceiver 1101, a controller 1102, and optionally, a memory 1103.

The transceiver 1201 is configured to receive and/or transmit signals.

The controller 1102 is operatively connected to the transceiver 1101 and/or the memory 1103. The controller 1102 may be implemented as one or more processors for operating according to any one or more of the methods described in various embodiments of the present disclosure.

The memory 1103 is configured to store computer programs and data. The memory 1103 may include a non-transitory memory for storing operations and/or code instructions executable by the controller 1102. The memory 1103 may include nontransitory programs and/or instructions readable by the processor, which, when executed, cause the controller 1102 to perform steps of any one or more methods according to various embodiments of the present disclosure. The memory 1103 may also include a random access memory or buffer (s) to store intermediate processing data from various functions performed by the controller 1102.

One of ordinary skill in the art will recognize that the description of the method of the present disclosure is only illustrative and is not intended to be limiting in any way. Other embodiments will readily occur to those of ordinary skill in the art having the benefit of this disclosure.

For the sake of clarity, not all the conventional features of the embodiments of the methods and devices of the present disclosure are shown and described. Of course, it should be understood that in the development of any such practical embodiments of the methods and devices for adjusting uplink transmit timing, many implementation-specific decisions may need to be made in order to achieve the developer's specific goals, such as compliance with applications, systems, networks and business-related constraints, and these specific goals will vary from implementation to implementation and from developer to developer.

The modules, processing operations and/or data structures described in accordance with the present disclosure may be implemented using various types of operating systems, computing platforms, network devices, computer programs and/or general-purpose machines. In addition, those skilled in the art will recognize that less common devices can also be used, such as hard-wired devices, Field Programmable Gate Array (FPGA), application specific integrated circuits (ASIC), etc. In the case that a method including a series of operations and sub-operations is implemented by a processor, computer or machine, and in the case that those operations and sub-operations can be stored as a series of non-transitory code instructions readable by the processor, computer or machine, they can be stored on tangible and/or non-transitory media.

The modules of the methods and devices described herein may include software, firmware, hardware or any combination (s) of software, firmware or hardware suitable for the purposes described herein.

In the methods described herein, various operations and sub-operations may be performed in various orders, and some of the operations and sub-operations may be optional.

Although the foregoing disclosure of this application has been made through nonlimiting illustrative embodiments, these embodiments can be arbitrarily modified within the scope of the appended claims without departing from the spirit and essence of this disclosure.

1-15. (canceled)

16. A method performed by a user equipment (UE) in a communication system, the method comprising:
transmitting UE capability information including information indicating a UE type associated with non-terrestrial network (NTN), wherein the UE type is one of a UE type 1 or a UE type 2;
receiving configuration information associated with the NTN;
determining a timing advance (TA) value for uplink transmission associated the NTN, after receiving the configuration information; and
transmitting the uplink transmission based on the TA value,
wherein an initial transmission timing error associated with the uplink transmission is less than or equal to ±T_{e_NTN}, and
wherein a value of the T_{e_NTN} is determined based on whether the UE type being the UE type 1 or the UE type 2.

17. The method of claim 16, wherein the value of the T_{e_NTN} is determined based whether the UE type being the UE type 1 or the UE type 2 in case that a frequency range (FR) associated with the NTN is FR2-1.

18. The method of claim 16,
wherein the value of the T_{e_NTN} is determined further based on a first subcarrier spacing (SCS) of synchronization signal block (SSB) signals, and a second SCS of uplink signals,
wherein in case that the UE type is the UE type 1:
in case that the first SCS being 120 kHz and the second SCS being 120 kHz, T_{e_NTN} is X₁₈*64*T_{c}, wherein a value of X₈ is within [4, 9], and
in case that the first SCS being 240 kHz and the second SCS being 120 kHz, T_{e_NTN} is X₂₀*64*T_{c}, wherein a value of X₁₀ is within [4, 9],
wherein in case that the UE type is the UE type 2:
in case that the first SCS being 120 kHz and the second SCS being 120 kHz, T_{e_NTN} is X₈*64*T_{c}, wherein a value of X₁₈ is within [4, 9], and
in case that the first SCS being 240 kHz and the second SCS being 120 kHz, T_{e_NTN} is X₁₀*64*T_{c}, wherein a value of X₂₀ is within [4, 9],
wherein T_{c}=1/(480*1000*4096).

19. The method of claim 16, wherein the UE type 1 is associated with the UE being positioning capability with high accuracy, and
wherein the UE type 2 is associated with the UE being positioning capability with low accuracy.

20. The method of claim 16, wherein the configuration information includes ephemeris information, and
wherein the configuration information is received in system information associated with the NTN.

21. A method performed by a base station in a communication system, the method comprising:
receiving user equipment (UE) capability information including information indicating a UE type associated with non-terrestrial network (NTN), wherein the UE type is one of a UE type 1 or a UE type 2;
transmitting configuration information associated with the NTN; and
receiving uplink transmission associated with the NTN, after transmitting the configuration information,
wherein the uplink transmission is associated with a timing advance (TA) value,
wherein an initial transmission timing error associated with the TA value is less than or equal to ±T_{e_NTN}, and
wherein a value of the T_{e_NTN} is determined based on the UE type.

22. The method of claim 21, wherein the value of the T_{e_NTN} is determined based whether the UE type being the UE type 1 or the UE type 2 in case that a frequency range, FR, associated with the NTN is FR2-1.

23. The method of claim 21,
wherein the value of the T_{e_NTN} is determined further based on a first subcarrier spacing (SCS) of synchronization signal block (SSB) signals, and a second SCS of uplink signals,
wherein in case that the UE type is the UE type 1:
in case that the first SCS being 120 kHz and the second SCS being 120 kHz, T_{e_NTN} is X₁₈*64*T_{c}, wherein a value of X₈ is within [4, 9], and
in case that the first SCS being 240 kHz and the second SCS being 120 kHz, T_{e_NTN} is X₂₀*64*T_{c}, wherein a value of X₁₀ is within [4, 9],
wherein in case that the UE type is the UE type 2:
in case that the first SCS being 120 kHz and the second SCS being 120 kHz, T_{e_NTN} is X₈*64*T_{c}, wherein a value of X₁₈ is within [4, 9], and
in case that the first SCS being 240 kHz and the second SCS being 120 kHz, T_{e_NTN} is X₁₀*64*T_{c}, wherein a value of X₂₀ is within [4, 9],
wherein T_{c}=1/(480*1000*4096).

24. The method of claim 21,
wherein the UE type 1 is associated with the UE being positioning capability with high accuracy, and
wherein the UE type 2 is associated with the UE being positioning capability with low accuracy.

25. The method of claim 21,
wherein the configuration information includes ephemeris information, and
wherein the configuration information is received in system information associated with the NTN.

26. A user equipment (UE) in a communication system, the UE comprising:
a transceiver; and
a processor coupled with the transceiver and configured to:
transmit UE capability information including information indicating a UE type associated with non-terrestrial network (NTN), wherein the UE type is one of a UE type 1 or a UE type 2;
receive configuration information associated with the NTN;
determine a timing advance (TA) value for uplink transmission associated the NTN, after receiving the configuration information; and
transmit the uplink transmission based on the TA value,
wherein an initial transmission timing error associated with the uplink transmission is less than or equal to ±T_{e_NTN}, and
wherein a value of the T_{e_NTN} is determined based on whether the UE type being the UE type 1 or the UE type 2.

27. The UE of claim 26, wherein the value of the T_{e_NTN} is determined based whether the UE type being the UE type 1 or the UE type 2 in case that a frequency range (FR) associated with the NTN is FR2-1.

28. The UE of claim 26,
wherein the value of the T_{e_NTN} is determined further based on a first subcarrier spacing (SCS) of synchronization signal block (SSB) signals, and a second SCS of uplink signals,
wherein in case that the UE type is the UE type 1:
in case that the first SCS being 120 kHz and the second SCS being 120 kHz, T_{e_NTN} is X₁₈*64*T_{c}, wherein a value of X₈ is within [4, 9], and
in case that the first SCS being 240 kHz and the second SCS being 120 kHz, T_{e_NTN} is X₂₀*64*T_{c}, wherein a value of X₁₀ is within [4, 9],
wherein in case that the UE type is the UE type 2:
in case that the first SCS being 120 kHz and the second SCS being 120 kHz, T_{e_NTN} IS X₈*64*T_{c}, wherein a value of X₁₈ is within [4, 9], and
in case that the first SCS being 240 kHz and the second SCS being 120 kHz, T_{e_NTN} is X₁₀*64*T_{c}, wherein a value of X₂₀ is within [4, 9],
wherein T_{c}=1/(480*1000*4096).

29. The UE of claim 26,
wherein the UE type 1 is associated with the UE being positioning capability with high accuracy, and
wherein the UE type 2 is associated with the UE being positioning capability with low accuracy.

30. The UE of claim 26,
wherein the configuration information includes ephemeris information, and
wherein the configuration information is received in system information associated with the NTN.

31. A base station in a communication system, the base station comprising:
a transceiver; and
a processor coupled with the transceiver and configured to:
receive user equipment (UE) capability information including information indicating a UE type associated with non-terrestrial network (NTN), wherein the UE type is one of a UE type 1 or a UE type 2;
transmit configuration information associated with the NTN; and
receive uplink transmission associated with the NTN, after transmitting the configuration information,
wherein the uplink transmission is associated with a timing advance (TA) value,
wherein an initial transmission timing error associated with the TA value is less than or equal to ±T_{e_NTN}, and
wherein a value of the T_{e_NTN} is determined based on the UE type.

32. The base station of claim 31, wherein the value of the T_{e_NTN} is determined based whether the UE type being the UE type 1 or the UE type 2 in case that a frequency range, FR, associated with the NTN is FR2-1.

33. The base station of claim 31,
wherein the value of the T_{e_NTN} is determined further based on a first subcarrier spacing (SCS) of synchronization signal block (SSB) signals, and a second SCS of uplink signals,
wherein in case that the UE type is the UE type 1:
in case that the first SCS being 120 kHz and the second SCS being 120 kHz, T_{e_NTN} is X₁₈*64*T_{c}, wherein a value of X₈ is within [4, 9], and
in case that the first SCS being 240 kHz and the second SCS being 120 kHz, T_{e_NTN} is X₂₀*64*T_{c}, wherein a value of X₁₀ is within [4, 9],
wherein in case that the UE type is the UE type 2:
in case that the first SCS being 120 kHz and the second SCS being 120 kHz, T_{e_NTN} is X₈*64*T_{c}, wherein a value of X₁₈ is within [4, 9], and
in case that the first SCS being 240 kHz and the second SCS being 120 kHz, T_{e_NTN} is X₁₀*64*T_{c}, wherein a value of X₂₀ is within [4, 9],
wherein T_{c}=1/(480*1000*4096).

34. The base station of claim 31,
wherein the UE type 1 is associated with the UE being positioning capability with high accuracy, and
wherein the UE type 2 is associated with the UE being positioning capability with low accuracy.

35. The base station of claim 31,
wherein the configuration information includes ephemeris information, and
wherein the configuration information is received in system information associated with the NTN.
